(19) United States
(12) Patent Application Publication
(10) Pub. No.: US 2015/0022755 A1
(43) Pub. Date: Jan. 22, 2015

(54) STRUCTURAL BACKLIGHTING

(71) Applicants: William Hamburgen, Palo Alto, CA (US); Amy Han, Palo Alto, CA (US)

(72) Inventors: William Hamburgen, Palo Alto, CA (US); Amy Han, Palo Alto, CA (US)

(73) Assignee: GOOGLE INC., Mountain View, CA (US)

(21) Appl. No.: 13/156,968

(22) Filed: Jun. 9, 2011

(51) Int. Cl. G02F 1/1335; H01J 9/24

(52) U.S. Cl. 349/62; 445/24

(57) ABSTRACT

A display assembly includes a display member and backlight member. The backlight member has a light source and is bonded directly to the display member. The backlight member can be bonded directly to a display area of the display member, and an optically transparent adhesive can be used to bond a first surface of the backlight member to a first surface of the display member.

### TECHNICAL FIELD

This description relates to display assemblies and more particularly to display assemblies that include tiled backlighting.

### BACKGROUND

Display assemblies are often used to provide a visual output of an electronic device. For example, display assemblies are used with computers (such as personal computers or laptop computers) and mobile telephone devices. Display assemblies are also included with televisions and other visual or video devices.

Many display assemblies include backlight units that are composed of many layers. In such display assemblies, the many layers are configured to distribute and focus the light from light sources disposed along an edge of a display member across the entire display area (or active area) of the display member.

As display assemblies are used in many portable electronic devices, it is desirable to provide display assemblies that are rigid, thin, and/or lightweight.

### SUMMARY

According to one general aspect of the invention, a display assembly includes a display member and backlight member. The backlight member has a light source and is bonded directly to the display member. In some implementations, the backlight member is bonded directly to a display area or active area of the display member. In some implementations, an optically transparent adhesive is used to bond a first surface of the backlight member to a first surface of the display member.

According to another general aspect of the invention, a display assembly includes a display member and plurality of light sources. The display member has a display area. The plurality of light sources are coupled to a surface of the display member within the display area of the display member. In some implementations, each of the plurality of light sources are coupled to a different backlight member.

According to another general aspect of the invention, a method of assembling a display includes providing a display member; providing a backlight member having a light source; and coupling a first surface of the backlight member to a first surface of the display member.

The details of one or more implementations are set forth in the accompanying drawings and the description below. Other features will be apparent from the description and drawings, and from the claims.

### BRIEF DESCRIPTION OF THE DRAWINGS

FIG. 1A is a schematic side view of a display assembly according to an implementation.

FIG. 1B is a schematic front view of the display of FIG. 1.

FIG. 2 is a perspective view of a device having a display assembly according to an implementation.

FIG. 3 is a cross-sectional side exploded view of the display assembly of FIG. 2 taken along line 3-3 of FIG. 2.

FIG. 4 is a rear view of a portion of the display assembly of FIG. 2.

FIG. 5 is a cross-sectional view of a portion of the display assembly of FIG. 2 taken along line 5-5 of FIG. 4.

FIGS. 5A and 5B are cross-sectional views of portions of display assemblies according to implementations.

FIG. 6 is a perspective view of a backlight member according to an implementation.

FIG. 7 is a front view of a housing member according to an implementation.

FIG. 8 is a rear view of a portion of a display assembly according to an implementation.

FIG. 9 is a rear view of a portion of a display assembly according to an implementation.

FIG. 10 is a flow chart of a method of assembling a display assembly according to an implementation.

### DETAILED DESCRIPTION

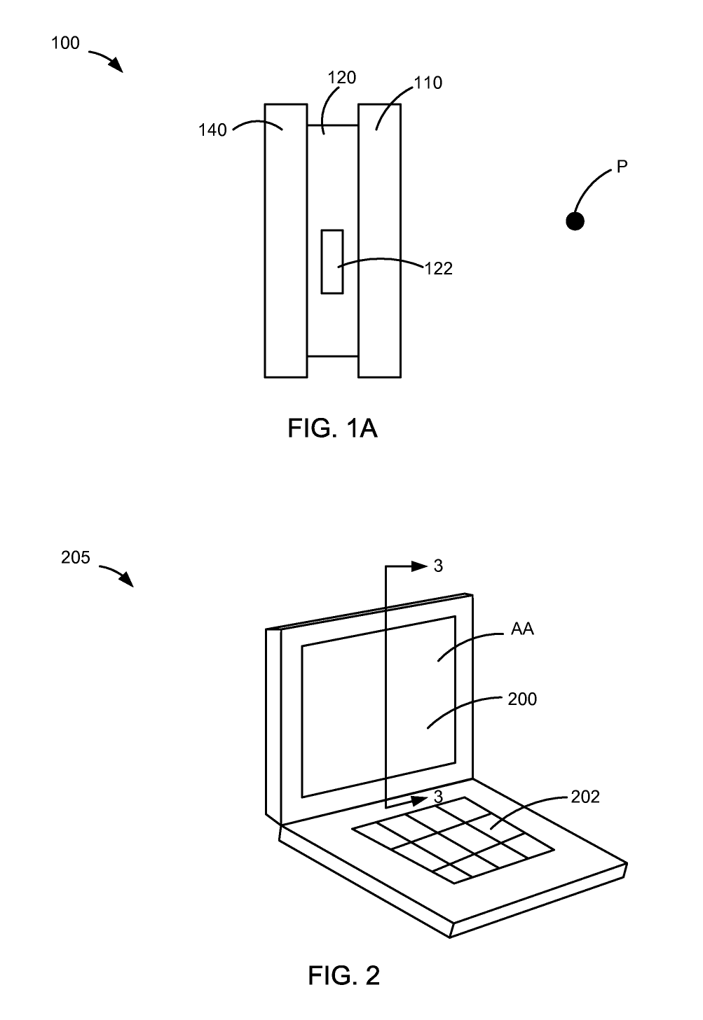

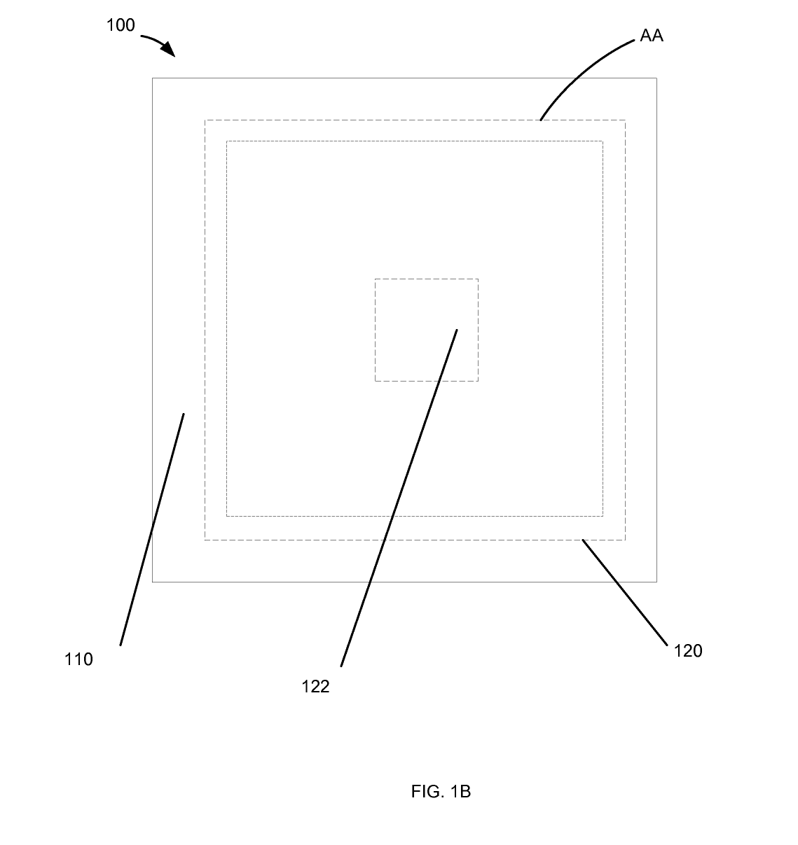

FIG. 1 is a schematic side diagram of a display assembly 100 with a person or user P disposed in front of the display assembly 100. The display assembly 100 includes a display member 110, a backlight layer 120, and a housing member 140. The display assembly 100 is configured to be operatively coupled to, or is part of, an electronic device and is configured to provide a visual output to a user of the electronic device. For example, in some implementations, the display assembly 100 is coupled to or is part of a computer (such as a personal computer or a laptop computer) and is configured to provide a visual output or display to a user of the computer. In other implementations, the display assembly 100 is coupled to, or is a part of, another electronic device (for example, a mobile phone, music device, or a television or video device) and is configured to provide a visual display or output to a user of the electronic device.

The display member 110 is coupled to a controller or processor that is configured to control the output or display of the display assembly 100. For example, in some implementations, the display member 110 is operatively coupled to a central processing unit of a computer. The central processing unit of the computer is configured to provide power to the display assembly 100 and is configured to control the output of display of the display assembly 100, for example, by controlling the light output from the backlight layer 120 and by controlling or modulating the intensity and/or color of light transmitted through individual pixels of the display member 110.

The display member 110 is configured to be viewed by the user of the electronic device and display assembly 100. The display member 110 provides or displays the images that are visible by the user. In some implementations, the display member 110 is a liquid crystal display. In other implementations, the display member 110 is another type of display device.

The backlight layer 120 is disposed adjacent the display member 110 and includes a light source 122. The light source 122 is configured to illuminate and provide the backlighting to the display member 110. In some implementations, the backlight layer 120 is coupled or bonded directly to the display member 110. For example, in some implementations, the backlight layer 120 includes a surface that is directly bonded to a surface of the display member 110 via an adhesive or other type of bonding material. In some implementations, an entire surface of the backlight layer 120 is directly bonded to a surface of the display member 110 via an adhesive or other type of bonding material.

In some implementations, the backlight layer 120 includes a plurality of distinct, individual backlight members. In some such implementations, each of the plurality of backlight members includes a light source. In some implementations, each of the plurality of backlight members includes a plurality of light sources. Additionally, in such implementations, each of the plurality of backlight members is coupled or bonded directly to the display member 110. For example, in some implementations, each of the plurality of backlight members includes a first surface and a second surface opposite the first surface. The first surface of each of the backlight members is coupled or bonded to an inner surface of the display member 110.

In some implementations, the backlight members are coupled or bonded to the display member 110 via a bonding material such as an adhesive. In other implementations, a different bonding material is used to couple the backlight members to the display member 110. In some implementations, the backlight members are coupled or bonded to the display member 110 via an optically clear or transparent bonding material.

FIG. 1B is a schematic front view of the display assembly 100. As illustrated, in some implementations, the display member 110 includes a visual or display area (the active area) AA (i.e., the area of the display member 110 that provides a visual output or display to the user of the display assembly 100). In some implementations, the backlight layer 120 (or the backlight members) are coupled to display member 110 within the visual or active area. In other words, in some implementations, the backlight layer 120 (shown in dashed lines) (or the backlight members) are coupled to an inner surface of the display member 110 within the display or active area (i.e., on an inner surface of the display member 110 directly opposite the portion of the outer surface of the display member 110 that provides a visual output to a user).

In the illustrated implementation, the display assembly 100 includes a housing member 140. The housing member 140 is configured to be coupled to the backlight layer 120 such that the backlight layer 120 is disposed between the housing member 140 and the display member 110.

In some implementations, the housing member 140 is directly coupled to the backlight layer 120. For example, in some implementations, a surface of the housing member 140 is coupled or bonded directly to a surface of the backlight layer 120. For example, in some implementations, the housing member 140 is coupled to the backlight layer 120 via an adhesive or other type of bonding material. In some implementations, the housing member 140 is coupled or bonded directly to the backlight layer 120 via a bonding material, such as an opaque adhesive. In some implementations, a surface of the housing member 140 is coupled or bonded directly to an entire surface of the backlight layer 120. In some implementations, the rear or back surface of the backlight layer 120 includes a reflective layer or reflective surface (such as a metallic or metalized layer or surface). In such implementations, the reflective layer or reflective surface of the backlight layer 120 is bonded to the housing member 140.

In some implementations, the housing member 140 includes support members. For example, in some implementations, the housing member 140 includes ribs or other support type structures disposed on an inner surface of the housing member 140. In some implementations, the support members are configured to provide structural support to the housing member 140 and the support assembly 100.

FIG. 2 is a perspective view of an electronic device, a laptop computer, 205. The device 205 includes a display assembly 200 and an input assembly 202. In the illustrated implementation, the display assembly 200 includes an active area. In the illustrated implementation, the input assembly 202 is a standard QWERTY keyboard and includes a plurality of input keys and a touch pad input device.

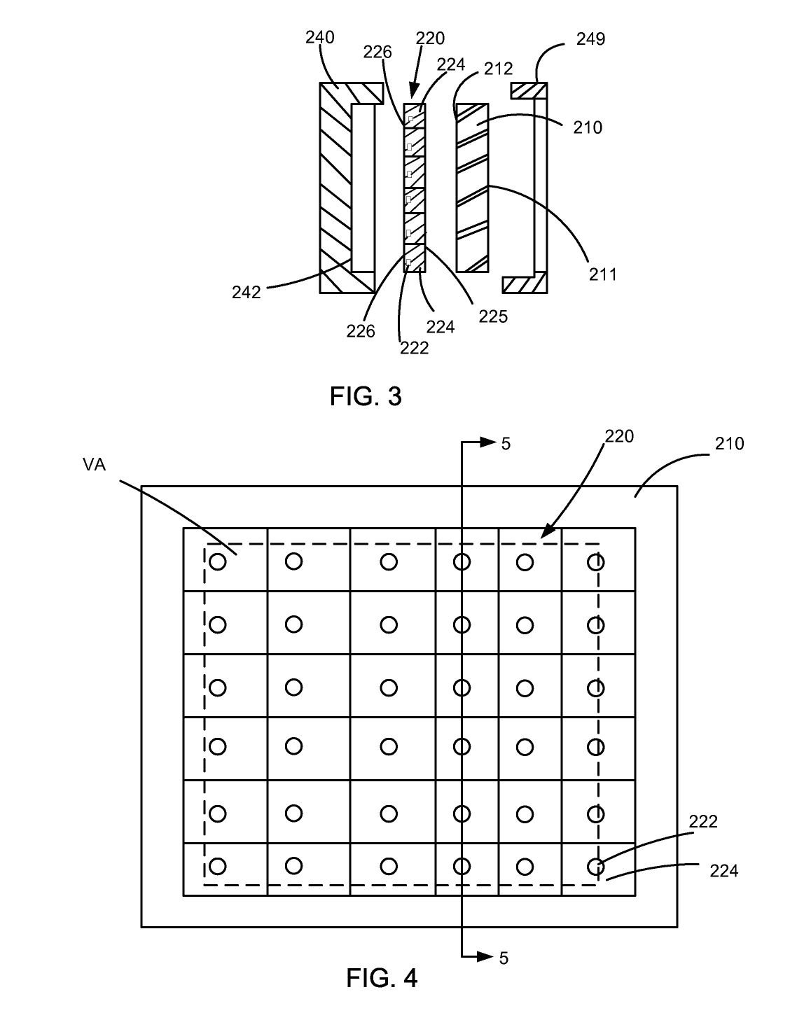

As illustrated in FIG. 3, the display assembly 200 includes a display member 210, a backlight layer 220, and a housing member 240. The illustrated implementation also includes a bezel member 249. The bezel member 249 may be coupled to, or integrated with, an edge portion of the housing member 240 such that the other portions or members of the display assembly 200 are disposed between the housing member 240 and the bezel member 249. In some implementations, the bezel member 249 is directly bonded to a glass display member 210.

The display assembly 200 is configured to be operatively coupled to a controller or processor of the laptop computer 205. For example, in some implementations, the display assembly 200 (such as the backlight layer 220 or the light source 222 of the backlight layer and the display member 210) is operatively coupled to the processer or central processing unit of the laptop computer 205. In such implementations, the processor or central processing unit controls the display assembly 200 to provide a visual output to a user of the electronic device 205.

The display member 210 is configured to be viewed by the user of the laptop computer 205. The display member 210 provides or displays the images that are visible by the user. In some implementations, the display member 210 is a liquid crystal display. In other implementations, the display member 210 is another type of display device. In some implementations, the display member 210 includes a polarizer or a polarizing layer.

For example, in some implementations, the display member 210 is a liquid crystal display. The liquid crystal display is operatively coupled to the processor or central processing unit of the electronic device. The processor or central processing unit of the electronic device is configured to control the liquid crystal display such that the light produced by the backlight layer 220 is converted into a viewable image by a user of the electronic device. For example, in some implementations, the processor or central processing unit is configured to effectuate changes in the liquid crystal display to allow selective amounts and colors of light to be emitted from each pixel of the display member 210.

The backlight layer 220 is disposed adjacent the display member 210 and is configured to illuminate and provide the backlighting to the display member 210. As described in more detail below, in the illustrated implementation, the backlight layer includes light sources 222 that are configured to illuminate, or provide backlighting to, the display member 210. In the illustrated implementation, the light sources 222 are light emitting diodes. For example, in some implementations, the light sources 222 are side-firing light emitting diodes. In other implementations, the light sources 222 are another type of light emitting or light generating device.

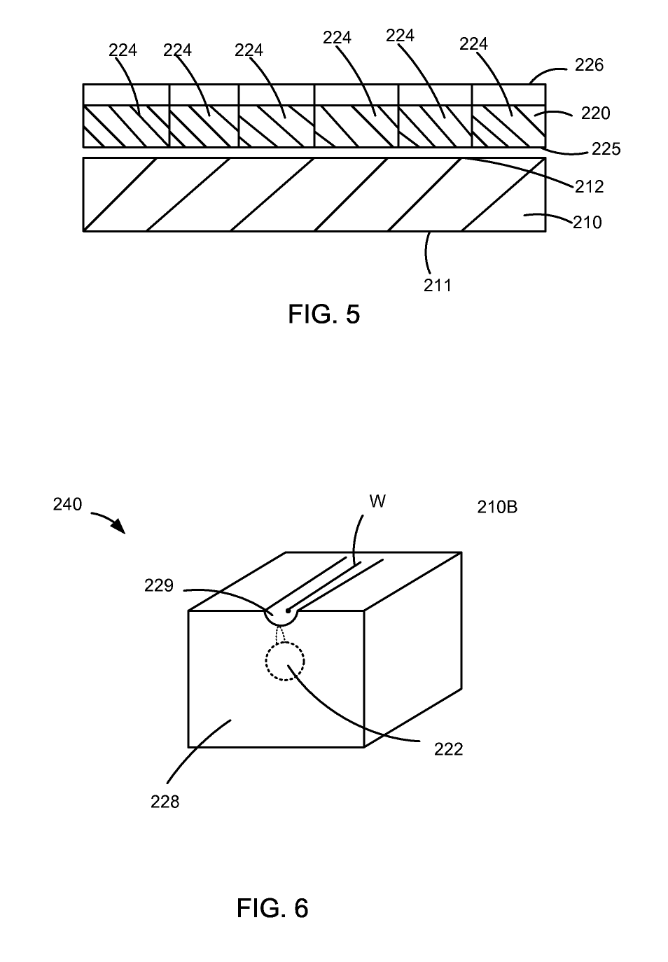

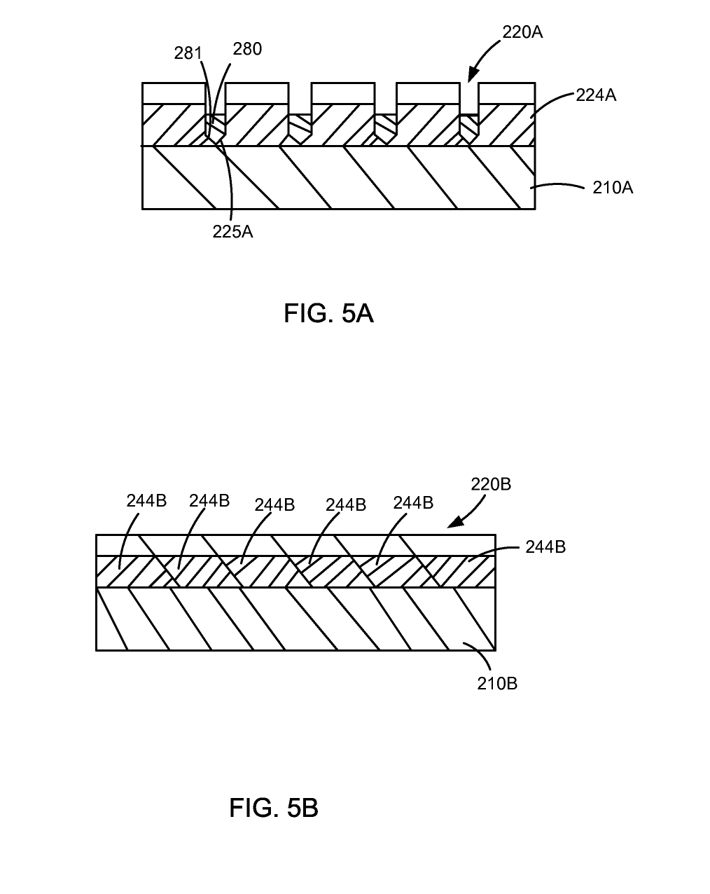

As best illustrated in FIGS. 4 and 5, in the illustrated implementation, the backlight layer 220 includes a plurality of backlight members or tiles 224. Each of the plurality of backlight members 224 is separate from the other backlight members. Each of the plurality of backlight members 224 includes a light source 222 (or light emitting diode).

Although the illustrated implementation shows each of the plurality of backlight members 224 as having a single light source 222, in some implementations, each of the plurality of backlight members 224 include more than one light source. For example, in some implementations, each of the plurality of backlight members 224 includes two light emitting diodes. In some such implementations, each of the plurality of backlight members 224 may include a white light emitting diode and a color light emitting diode. In some implementations, each backlight member 224 includes a plurality of white light sources. In other implementations, each backlight member 224 includes a white light source and a colored light source (such as a red light source or a green light source). In some implementations, each backlight member 224 includes a plurality of white light sources and a plurality of colored light sources.

In the illustrated implementation, each of the backlight members 224 includes a first surface 225 and a second surface 226 opposite the first surface 225. The first surface 225 faces the display member 210. The display member 210 includes an outer surface 211 (visible to the user of the laptop computer 205) and an inner surface 212 opposite the outer surface 211.

As shown in FIG. 5, the first surface 225 of each of the backlight members 224 is disposed adjacent and coupled or bonded to the inner surface of the display member 210. In some implementations, a planar surface of the backlight members 224 is area bonded to a planar surface of the display member 210.

In some implementations, an optically clear adhesive is used to couple or bond the backlight members 224 to the display member 210. In some implementations, the optically clear adhesive forms a layer of approximate uniform thickness between each of the backlight members 224 and the display member 210. In some implementations, a liquid adhesive is used to couple of bond each of the backlight members 224 to the display member 210. In other implementations, a film adhesive is used to couple or bond each of the backlight members 224 to the display member 210.

In some implementations, a pressure is applied to the backlight members 224 and the display member 210 as the adhesive used to couple the members dries or cures. In other implementations, radiation, such as ultraviolet radiation is used to cure the adhesive used to coupled or bond the backlight members 224 to the display member 210. In some implementations, a silicone, an acrylic, or an epoxy is used to couple or bond the backlight members 224 to the display member 210. In some implementations, Liquid Optically Clear Adhesive 2152A or 2175 manufactured by 3M may be used to couple or bond the backlight members 224 to the display member 210.

As best illustrated in FIGS. 2 and 4, the display member 210 of the display assembly 200 includes a display area or active area AA. The display area or active area AA is the area or portion of the display member 210 that provides an image or visual output to a user of the display assembly 200. For example, the active area AA is the area or portion of the display member 210 that provides a visual output to a user of the laptop computer 205.

The backlight members 224 are coupled to the display member 210 within the active area AA of the display member 210. Specifically, in the illustrated implementation, the backlight members 224 are coupled to the inner surface 212 of the display member 210 within the active area AA (i.e., at a location on the inner surface 212 of the display member 210 that is opposite the portion of the outer surface 211 of the display member 210 that provides a visual output to a user). Specifically, in the illustrated embodiment, each of the backlight members 224 are individually coupled or bonded to the inner surface 212 of the display member 210. For example, in some implementations, an entire surface of each of the backlight members 224 are coupled or bonded to the inner surface 212 of the display member 210.

Although the illustrated implementation includes an array of six rows and six columns of backlight members 224, in other implementations, the backlight layer 220 includes any number of backlight members 224. For example, in some implementations, the backlight layer 220 includes 25, 49, 64, or any number of backlight members 224.

FIG. 5A is a cross-sectional view of a portion of a display assembly according to an implementation. In the illustrated implementation, the backlight layer 220A includes a grid or frame 280 that is configured to receive and provide support to the backlight members 224A that are bonded to or coupled to the display member 210A. For example, in the illustrated implementation, the grid or frame 280 is disposed between portions of the individual backlight members 224A. Additionally, in the illustrated implementation, the grid or frame 280 includes tapered portions 281 and the backlight members 224A include tapered or flared portions 225A that are disposed proximate the display member 210A. The tapered or flared portions 225A can be included so that the light delivered from the multiple backlight members 224A to the display member 210A is homogeneously distributed across the surface of the display member, even though the grid or frame 280 is disposed between portions of the backlight members 224A that are distal from the display member 210A. The tapered or flared portion 225A of the backlight members 224A can begin anywhere along the height of the backlight members and continue toward the display member 210A, so that at the surface of the display member, or even at a distance up from the surface, neighboring backlight members 224A are in contact with each other and therefore can supply homogeneously to the display member 210A. In other implementations, spacers may be disposed between the backlight members.

FIG. 5B is a cross-sectional view of a portion of a display assembly according to an implementation. In the illustrated implementation, the backlight members 224B are coupled or bonded to the display member 210B may include tapered or angled side surfaces. The tapered or angled side surfaces may facilitate the interconnection or association between each of the backlight members 224B with the immediately adjacent backlight members 224B. For example, the tapered or angled side surfaces may allow for each backlight member 224B to interact with a larger surface of the backlight members 224B immediately adjacent each backlight member 224B to allow for a better interconnection or association between the backlight members 224B. Further, the tapered or angled side surfaces may minimize or eliminate any gap or space between the backlight members 224B.

FIG. 6 is a perspective view of a backlight member 224. The backlight member 224 includes a block or housing that houses or includes the light source 222. In some implementations, the backlight member 224 is a monolithic block. In some implementations, the backlight member 224 is molded into its block or tile shape. In some implementations, the block or housing is formed of a transparent material. In some implementations, the block or housing is formed of a transparent or partially transparent polymer material. In some implementations, the backlight member 224 is formed of polymethyl acrylate or polycarbonate.

In some implementations, the backlight member 224 includes a light diffusing portion 228. The light diffusing portion 228 is disposed between the light source 222 and the first surface 225 (and thus, between the light source 222 and the display member 210).

The light diffusing portion 228 is configured to appropriately diffuse the light emitted by the light source 222. For example, in some implementations, the light diffusing portion 228 is configured to evenly direct the light emitted by the light source 222 to the inner surface 212 of the display member 210. In other implementations, the light diffusing portion 228 is configured to selectively direct light emitted by the light source 222 to the inner surface 212 of the display member 210. For example, in some implementations, the light diffusing portion 228 may be configured to direct a larger amount of light to a selected portion of the inner surface 212 of the display member 210.

In the illustrated implementation, the backlight member 224 includes or defines a groove or a channel 229. The groove or channel 229 is defined by the second surface 226 of the backlight member 224. The groove or channel 229 is configured to receive a wire or set of wires to allow the light source 222 of the backlight member 224 to be operatively coupled to a processor or controller to actively control the illumination or output of the light source 222. For example, in some implementations, the groove or channel 229 of each of the backlight members 224 are aligned and allow the wires W to extend from one edge or side portion of the display assembly to each of the light sources 222.

In some implementations, once the backlight members 224 are formed, the backlight members 224 may be individually tested. For example, the backlight members 224 may be individually tested to confirm that the backlight members 224 are functioning properly. For example, the backlight members 224 may be tested to confirm that the backlight members 224 are appropriately diffusing the light generated by the light source 222. In some implementations, the backlight members 224 may be grouped according to the characteristics of the individual backlight members 224. For example, in some implementations, backlight members 224 that produce a similar amount of light for the same amount of electrical input current may be grouped together and used in the same display assembly. In other implementations, backlight members that diffuse the light generated by the light sources in a similar manner may be grouped together and used in the same display assembly. In other implementations, backlight members that produce or emit light of the same or similar wavelength may be grouped together and used in the same display assembly.

In some implementations, the backlight members 224 include a sensor such as a feedback sensor. The sensor may be configured to detect the amount of light or the manner in which the light is diffused by the backlight member 224. In some implementations, the sensor may allow for detection and adjustment for changes in the characteristics of the backlight members 224 (such as due to aging of the backlight members). In some implementations, the detection and adjustment may allow the electrical power provided to each backlight light member 224 to vary to account for differences in the diffusion or wavelength characteristics. In some such implementations, the backlight members 224 may be adjusted to be uniform and eliminate the need to group backlight members 224 with similar characteristics.

In the illustrated implementation, the display assembly 200 includes a housing member 240. The housing member 240 is configured to be coupled to the backlight layer 220 such that the backlight layer 220 is disposed between the housing member 240 and the display member 210.

In some implementations, the housing member 240 is directly coupled to the backlight layer 220. For example, in some implementations, a surface 242 of the housing member 240 is coupled or bonded directly to a surface of the backlight layer 220. In the illustrated implementation, the surface 242 of the housing member 240 is coupled or bonded to the second surfaces 226 of the backlight members 224. For example, in some implementations, the housing member 240 is coupled to the backlight layer 220 or the backlight members 224 via an adhesive or other type of bonding material. For example, in some implementations, the housing member 240 is coupled or bonded directly to the backlight layer 220 or the backlight members 224 via an opaque bonding material.

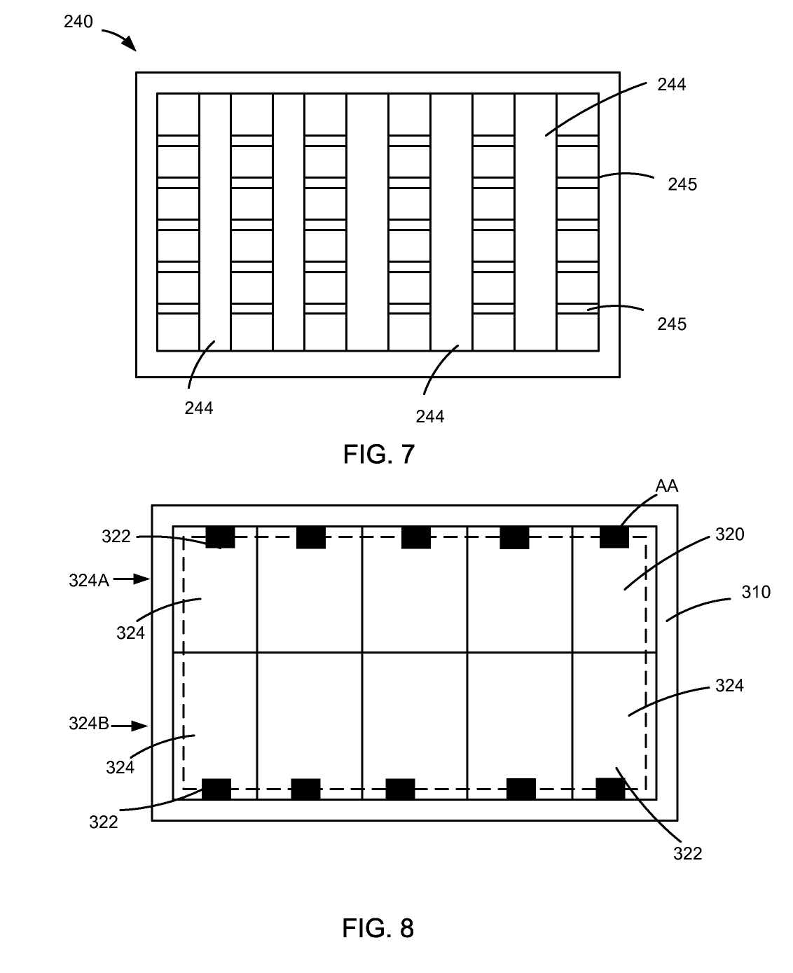

FIG. 7 is a front view of the housing member 240. In some implementations, the housing member 240 includes support elements 244 and 245. The support elements 244 are vertical support elements and the support elements 245 are horizontal support elements. The support elements 244 and 245 are configured to provide structural support to the housing member 240 and to the display assembly 200. In some implementations, the support elements are configured to be coupled or bonded directly to the individual backlight members 224. In other implementations, the support elements 244 and 245 are configured to be disposed between or along portions of the individual backlight members.

Although the support elements 244 and 245 are illustrated in a particular relationship to each other, in other implementations, the support elements are arranged in a different pattern. For example, in some implementations, the support elements are disposed in a parallel relationship. In other implementations, the support elements are randomly disposed or coupled to a portion of the housing member 240.

FIG. 8 is a rear view of a backlight layer 320 and a display member 310. The backlight layer 320 includes a plurality of backlight members 324. Each of the plurality of backlight members 324 includes a light source 322.

The backlight members 324 are each coupled or bonded directly to the display member 310. For example, in some implementations, a surface of each of the backlight members 324 is coupled or bonded to the display member 310. Each of the backlight members 324 are coupled or bonded to the display member 310 within the active area AA of the display member 310.

In the illustrated implementation, the backlight layer 320 includes two rows of backlight members 324. For example, the backlight layer 320 includes an upper row 324A of backlight members 324 and a lower row 324B of backlight members 324. The light sources 322 of the backlight members 324 are arraigned along end portions of the backlight members 324. The backlight members 324 are configured to diffuse and direct the light emitted by the light sources 322 to the display member 310. For example, in some implementations, the backlight members 324 include light diffusing portions disposed between the light sources 322 and the display member 310 and are configured to disperse or diffuse the light emitted from the light sources 322 to the display member 310. In the illustrated implementation, the light sources 322 are disposed along the edges of the backlight layer 320.

In some implementations, the backlight layer may facilitate the use of content adaptive backlight control schemes. For example, in some implementations, the backlight members 324 of the upper row 324A may have different characteristics than the backlight members 324 of the lower row 324B. For example, the backlight members 324 of the upper row 324A may be dimmed or highlighted in comparison to the backlight members 324 of the lower row 324B to provide for different viewing or display characteristics of the display member 310.

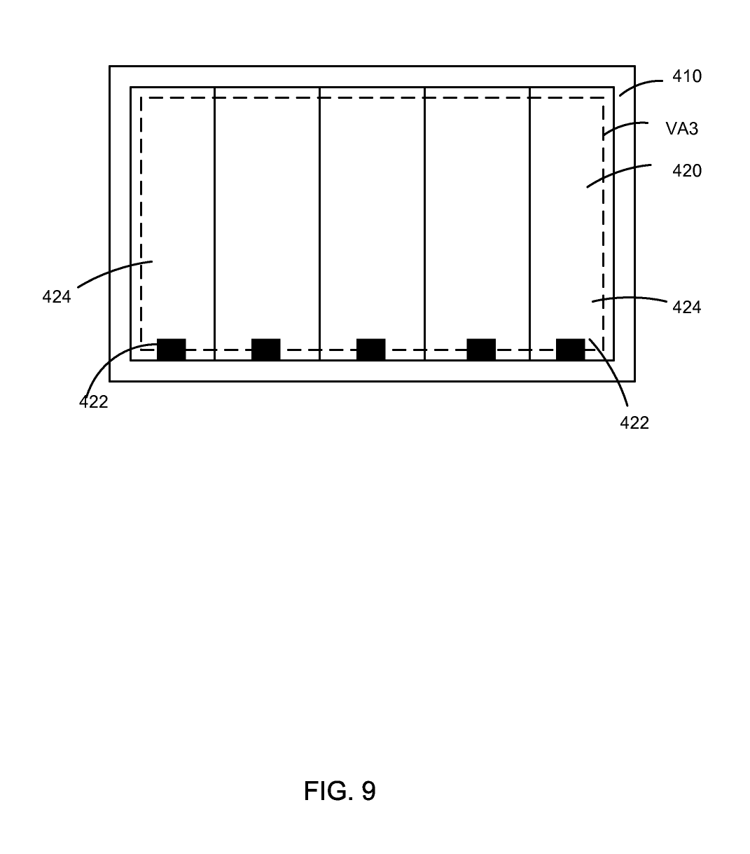

FIG. 9 is a rear view of a backlight layer 420 and a display member 410. The backlight layer 420 includes a plurality of backlight members 424. Each of the plurality of backlight members 424 includes a light source 422.

The backlight members 424 are each coupled or bonded directly to the display member 410. For example, in some implementations, a surface of each of the backlight members 424 is coupled or bonded to the display member 410. Each of the backlight members 424 are coupled or bonded to the display member 410 within the active area AA3 of the display member 410.

In the illustrated implementation, the backlight layer 420 includes a single row of backlight members 424. Each of the backlight members 424 extend from one end or edge portion of the backlight layer 420 to an opposite end or edge portion of the backlight layer 420. The light sources 422 of the backlight members 424 are arranged along end or edge portions of the backlight members 424.

The backlight members 424 are configured to diffuse and direct the light emitted by the light sources 422 to the display member 410. For example, in some implementations, the backlight members 424 include light diffusing portions disposed between the light sources 422 and the display member 410 (for example, along the length of the backlight members 424) and are configured to disburse or diffuse the light emitted from the light sources 422 to the display member 410.

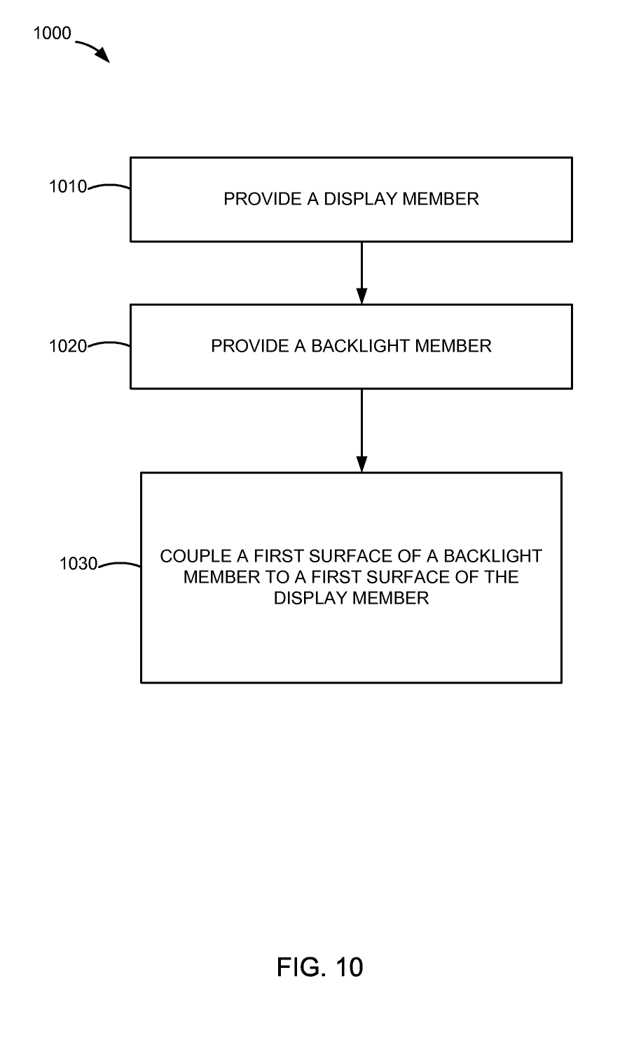

FIG. 10 is a flow chart illustrating a method 1000 of forming or manufacturing a display assembly. The method 1000 includes at 1010 providing a display member. The display member is configured to be operatively coupled to an electronic device, such as a computer, mobile phone, or other type of electronic device. The display member is configured to provide a visual display or output to a user of the device. In some implementations, the display member is a liquid crystal display member. In other implementations, the display member is a different type of display member.

In some implementations, the display member includes an outer surface and an inner surface opposite the outer surface. The outer surface is configured to provide a visual output or display to the user of the display assembly or electronic device. In some implementations, the display member defines a display area or region. The display area or active area or region is the area or region of the display member that provides the visual output of display to the user.

At 1020, a backlight member is provided. The backlight member is configured to illuminate or provide illumination for the display member. In some implementations, the backlight member includes a light source that is configured to provide illumination to the display member. In some implementations, the light source is a light emitting diode. In other implementations, the light source is a different type of light source. The backlight member includes a first surface and a second surface opposite the first surface.

At 1030, the backlight member is coupled or bonded to the display member. In some implementations, the first surface of the backlight member is coupled or bonded to the inner surface of the display member. In some implementations, the backlight member is area bonded to the display member. In some implementations, the backlight member is coupled to the display member within the display area of the display member. For example, in some implementations, the backlight member is coupled to a portion of the inner surface of the display member that is opposite a display portion of the outer surface of the display member.

In some implementations, an adhesive, such as an optically transparent adhesive, is disposed between or on one or both of the backlight member and the display member to bond or couple the backlight member to the display member. For example, in some implementations, a liquid adhesive is used to couple the backlight member to the display member. In other implementations, a film adhesive is used to couple the backlight member to the display member.

In some implementations, the adhesive used to couple the backlight member to the display member is pressure activated or cured. In such implementations, once the adhesive is applied, a pressure is applied to one or both of the backlight member and the display member to cure the adhesive. In other implementations, the adhesive used to couple the backlight member to the display member is activated or cured by applying a radiation to the adhesive. For example, in some implementations, once the adhesive is applied, the adhesive is exposed to ultraviolet radiation to cure or harden the adhesive.

In some implementations, more than one backlight members are coupled or bonded to the display member. For example, in some implementations, a plurality of backlight members is coupled to the display member.

In some implementations, a housing member is coupled or bonded to the backlight member. For example, the housing member may be coupled to the backlight member such that the backlight member is disposed between the housing member and the display member. In some implementations, an adhesive is used to couple the housing member to the backlight member. For example, an optically transparent or an optically opaque adhesive may be used to couple the housing member to the backlight member.

In some implementations, the individual backlight members are individually tested and grouped or binned with backlight members that have similar characteristics. In such implementations, backlight members that have similar characteristics (such as backlight members that produce a similar amount of light or backlight members that diffuse light in a similar manner) may be used in the same display assembly.

In some implementations, a bezel is coupled to the display member. For example, in some implementations, the bezel is coupled to the outer surface of the display member and provides an outline or a frame for the viewing area of the display member.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A display assembly, comprising:
a display member, the display member being configured to be operatively coupled to a processor and configured to modulate light to produce an image; and
a plurality of backlight members, each backlight member being separate from each other backlight member, each backlight member having a plurality of embedded light sources including at least one white light source and at least one color light source, each backlight member being configured to supply the light that is modulated by the display member, an entire surface of each backlight member being bonded directly to the display member.

2. The display assembly of claim 1, wherein the display member includes an inner surface and an outer surface opposite the inner surface, each backlight member is bonded directly to the inner surface of the display member.

3. The display assembly of claim 1, wherein the display member has a display area, each backlight member being bonded directly to the display area of the display member.

4. The display assembly of claim 1, wherein each backlight member is bonded directly to the display member via an adhesive.

5. The display assembly of claim 1, wherein each backlight member is bonded directly to the display member via an optically transparent adhesive.

6. The display assembly of claim 1, each backlight member is a separate monolithic block having the plurality of embedded light sources, and each separate monolithic block being bonded directly to the display member.

7. The display assembly of claim 1, further comprising:
a housing, the housing being coupled to each backlight member such that each backlight member is disposed between the display member and the housing.

8. The display assembly of claim 1, further comprising:
a housing member, the housing being bonded directly to each backlight member via an adhesive such that each backlight member is disposed between the display member and the housing member.

9. The display assembly of claim 1, further comprising:
a frame configured to receive and support the backlight members that are bonded to the display member, the frame including tapered portions configured to couple with tapered portions of the backlight members.

10. The display assembly of claim 1, wherein the display member is a liquid crystal display.

11. The display assembly of claim 1, wherein each backlight member is monolithic, and each backlight member includes angled side surfaces configured to interconnect with neighboring backlight members.

12. A display assembly, comprising:
a display member, the display member having a display area;
a first backlight member defined as a first monolithic block having a first plurality of light sources including at least one white light source and at least one color light source, and being configured to supply first light that is modulated by the display member, the first backlight member being bonded directly to a surface of the display member within the display area of the display member; and
a second backlight member defined as a second monolithic block having a second plurality of light sources including at least one white light source and at least one color light source, and being configured to supply second light that is modulated by the display member, the second backlight member being bonded directly to the surface of the display member within the display area of the display member.

13. The display assembly of claim 12, wherein the first backlight member includes a first surface and a second surface opposite the first surface, the display member includes an inner surface and an outer surface opposite the inner surface, and the entire outer surface of the backlight member is coupled to the inner surface of the display member.

14. The display assembly of claim 12, further comprising:
a housing member coupled to the plurality of light sources such that the plurality of light sources are disposed between the housing and the display.

15. A method of assembling a display, comprising:
providing a display member;
providing a plurality of individual backlight members, each individual backlight member being a separate monolithic block from each other individual backlight member, each individual backlight member having multiple embedded light sources including at least one white light source and at least one color light source; and
directly bonding an entire first surface of each individual backlight member to a first surface of the display member.

16. The method of claim 15, wherein the directly bonding includes applying an adhesive to at least one of the first surface of the display member and the first surface of each individual backlight member.

17. The method of claim 15, wherein the directly bonding includes applying an adhesive to at least one of the first surface of the display member and the first surface of each individual backlight member and applying a pressure to at least one of the display and each individual backlight member.

18. The method of claim 15, wherein the directly bonding includes applying an adhesive to at least one of the first surface of the display member and the first surface of each individual backlight member and exposing the adhesive to ultraviolet radiation to cure the adhesive.

19. The method of claim 15, wherein the directly bonding includes directly bonding the first surface of each individual backlight member to a portion of the first surface of the display member, the portion of the first surface of the display member being within a display area of the display member.

20. The method of claim 15, wherein directly bonding includes directly bonding each separate monolithic block to the first surface of the display member using an adhesive.

21. The method of claim 15, further comprising:
directly bonding a housing member to each backlight member such that each backlight member is disposed between the housing and the display member.

22. The method of claim 15, wherein the display member is a liquid crystal display and each light source is a light emitting diode.

23. The display assembly of claim 12, further comprising:
one or more additional backlight members with each additional backlight member having multiple light sources including at least one white light source and at least one color light source, and being configured to supply light that is modulated by the display member, the one or more additional backlight members being bonded directly to the surface of the display member within the display area of the display member.

24. The display assembly of claim 12, wherein each backlight member is separate from each other backlight member, and each backlight member is bonded directly to the surface of the display member within the display area of the display member using an adhesive.

25. The display assembly of claim 12, wherein each backlight member is a separate monolithic block, and each separate monolithic block is bonded directly to the surface of the display member within the display area of the display member.

26. The display assembly of claim 12, further comprising:
a frame configured to receive and support the backlight members that are bonded to the display member, the frame including tapered portions configured to couple with tapered portions of the backlight members.

27. The display assembly of claim 12, wherein each backlight member includes angled side surfaces configured to interconnect with neighboring backlight members.

28. The method of claim 15, further comprising:
providing a frame configured to receive and support the backlight members that are bonded to the display member, the frame including tapered portions configured to couple with tapered portions of the backlight members.

29. The method of claim 15, wherein each backlight member includes angled side surfaces configured to interconnect with neighboring backlight members.
